(19) United States
(12) Patent Application Publication
(10) Pub. No.: US 2013/0285869 A1
(43) Pub. Date: Oct. 31, 2013

(54) ANTENNA SYSTEM FOR WIRELESS COMMUNICATION

(71) Applicants: AMBIT MICROSYSTEMS (SHANGHAI) LTD., Shanghai (CN); HON HAI PRECISION INDUSTRY CO., LTD., New Taipei (TW)

(72) Inventors: CHO-JU CHUNG, New Taipei (TW); GUAN-RUN TAO, Shanghai (CN)

(73) Assignees: HON HAI PRECISION INDUSTRY CO., LTD., New Taipei (TW); AMBIT MICROSYSTEMS (SHANGHAI) LTD., Shanghai (CN)

(21) Appl. No.: 13/853,148

(22) Filed: Mar. 29, 2013

(30) Foreign Application Priority Data
Apr. 28, 2012 (CN) 201210132784.4

(51) Int. Cl. H01Q 15/14

(52) U.S. Cl. CPC H01Q 15/14
USPC 343/835

(57) ABSTRACT

The antenna system includes a substrate, a first antenna, a second antenna and a reflection portion. The substrate is a printed circuit board (PCB), and includes a vacancy portion and a metal ground portion. The vacancy portion includes a radio frequency (RF) component portion and a non-RF component portion. The RF component portion includes some radio frequency components. In order to transmit and receive electromagnetic signal, the radio frequency components are electronically connected to the first antenna and the second antenna.

### BACKGROUND

1. Technical Field

Embodiments of the present disclosure generally relate to wireless communications, and more particularly to an antenna system.

2. Description of Related Art

A printed antenna, is often used in an electronic device. However, printed antennas often fail to offer a radiation pattern with a high gain at interested orientation with a wide angle.

In order to transmit and receive signals, a usual antenna changes its radiation pattern by adjusting resonance frequency of a figure etched in a copper foil, but such antennas have an unclear direction radiation pattern and low front direction gain, and its gain changes in connection with its angle.

### BRIEF DESCRIPTION OF THE DRAWINGS

FIG. 1 is a front view of an embodiment of an antenna system in accordance with the present disclosure.

FIG. 2 is a side view of an embodiment of an antenna system in accordance with the present disclosure.

FIG. 3 is a solid view of an embodiment of an antenna system in accordance with the present disclosure.

FIG. 4 is a schematic diagram of an embodiment of a structure of a first antenna in accordance with the present disclosure.

FIG. 5 is a schematic diagram of an embodiment of an exemplary structures of a substrate, a reflection portion and a metal shielding cover with designated sizes in accordance with the present disclosure.

FIG. 6 is a schematic diagram of another embodiment of an exemplary structures of a substrate, a reflection portion and a metal shielding cover with designated sizes in accordance with the present disclosure.

FIG. 7 is a schematic diagram of an embodiment of an exemplary structure of a first antenna with designated sizes in accordance with the present disclosure.

FIG. 8 is a test diagram of an embodiment of a voltage standing wave ratio (VSWR) of an antenna system.

FIG. 9 is a diagram showing an exemplary radiation pattern on an X-Y horizontal plane when the antenna system of FIG. 1 operates at 2.4 gigahertz (GHz).

FIG. 10 is a diagram showing an exemplary radiation pattern on an X-Y horizontal plane when the antenna system of FIG. 1 operates at 2.45 gigahertz (GHz).

FIG. 11 is a diagram showing an exemplary radiation pattern on an X-Y horizontal plane when the antenna system of FIG. 1 operates at 2.5 gigahertz (GHz).

### DETAILED DESCRIPTION

The application is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

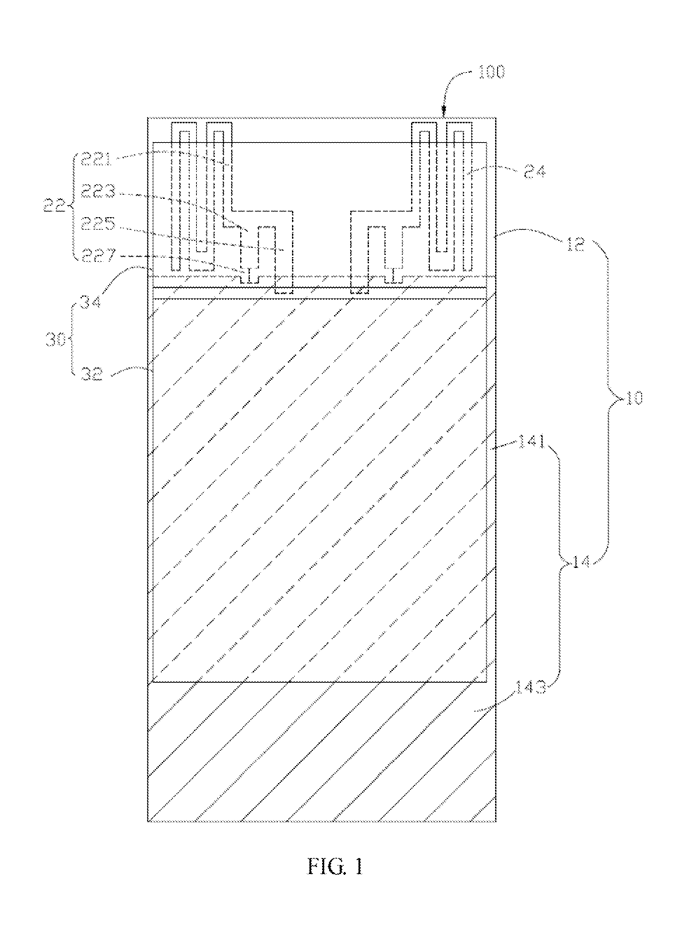

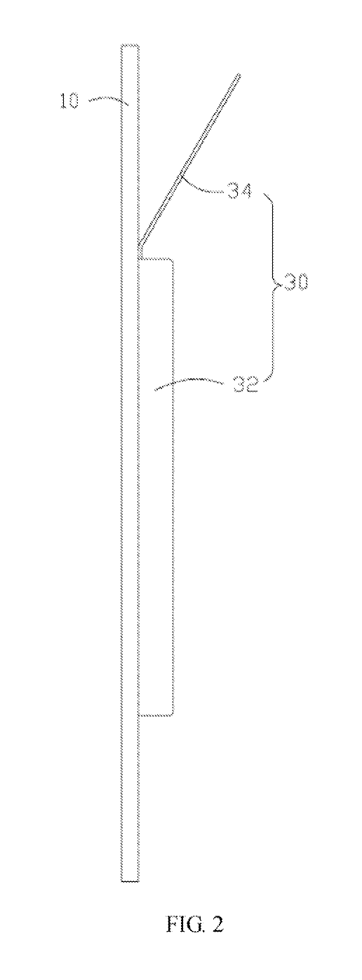

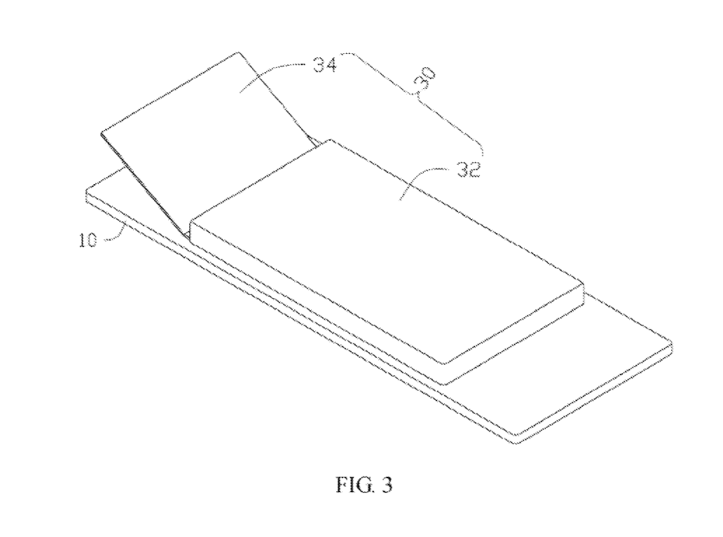

FIG. 1, FIG. 2 and FIG. 3 are one embodiment of front, side and solid views of an antenna system 100 in accordance with the present disclosure. In the present embodiment, the antenna system 100 includes a substrate 10, a first antenna 22, a second antenna 24, and a reflection portion 30.

Referring to FIG. 1, the substrate 10 is a printed circuit board (PCB), and includes a vacancy portion 12 and a metal ground portion 14. The metal ground portion 14 includes a radio frequency (RF) component portion 141 and a non-RF component portion 143. The RF component portion 141 includes radio frequency components. In order to transmit and receive electromagnetic signals, the radio frequency components are electronically connected to the first antenna 22 and the second antenna 24. With the exception of radio frequency component, the non-RF component portion 143 includes electronic components, such as digital circuits.

The first antenna 22 and the second antenna 24 are symmetric along an axis. Both of the first antenna 22 and the second antenna 24 include a first radiation portion 221, a second radiation portion 223, a third radiation portion 225 and a metal feeding line 227. In one embodiment, the metal feeding line 227 receives electromagnetic signal from a wireless transceiver disposed in the RF component portion 141.

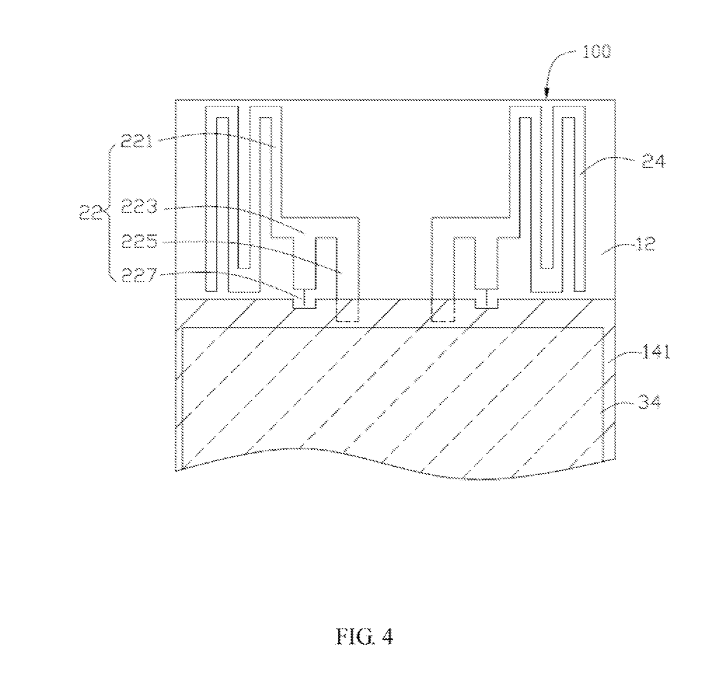

FIG. 4 is a schematic diagram of an embodiment of a structure of the first antenna 22 in accordance with the present disclosure. In one embodiment, the first antenna 22 has a same structure as the second antenna 24, and the following introduces the present disclosure in detail by mainly taking the first antenna 22 as an example.

The first antenna 22 is disposed on the vacancy portion 12, and the length of the first antenna is equal to a quarter of wavelengths of electromagnetic signal radiated by itself. In one embodiment, the first radiation portion 221, the second radiation portion 223 and the third radiation portion 225 are connected in series. The first radiation portion 221 has a selective one of an S-shaped configuration and an M-shaped configuration, the second radiation portion 223 has a T-shaped configuration, and the third radiation portion 225 has a long striped configuration. The second radiation portion 223 and the third radiation portion 225 collectively form an F shape. A first terminal of the first radiation portion 221 is a free terminal, which is perpendicular to a part of the metal ground portion 14 close to the vacancy portion 12. A second terminal of the first radiation portion 221 is perpendicularly connected to a first terminal of the second radiation portion 223. A second terminal of the second radiation portion 223, located in the same plane as the first terminal of the second radiation portion 223, is perpendicularly connected to a first terminal of the third radiation portion 225. A second terminal of the third radiation portion 225 is perpendicularly and electronically connected to the metal ground portion 14 of the substrate 10. In the present embodiment, a first terminal of the metal feeding line 227 of the first antenna 22 is connected to a middle protruding terminal of the second radiation portion 223. A second terminal of the metal feeding line 227 is coupled with the vacancy portion 12 to feed electromagnetic signals to the first antenna 22.

Referring to FIG. 3, the reflection portion 30 includes a metal shielding cover 32 and a metal reflection board 34. In the present embodiment, the metal shielding cover 32 covers the RF component portion 141 of the metal ground portion 14 to avoid electromagnetic interference, which might be caused by the antenna system 100 itself or by other external electronic devices. For example, if the antenna system 100 is used in a cell phone A, the metal shielding cover 32 of the antenna system 100 can protect the antenna system 100 from interference caused by a cell phone B around the antennal system 100, and also protect the cell phone B from interference caused by the antennal system 100, which makes the cell phone A and B work well. In one embodiment, the metal shielding cover 32 can protect electronic components in the non-RF component portion 143 from interference caused by RF components in the RF component portion 141.

A first part of the metal reflection board 34 is connected to a first part of the metal shielding cover 32 close to the vacancy portion 12, and a second part of the metal reflection board 34 is angulated at an angle of 0-90 degrees (such as 15, 30, 45, 60 and 75 degrees) to the vacancy portion 12 in order to change a radiation pattern of the antenna system 100. The first antenna 22 and the second antenna 24, taking advantage of the metal reflection board 34, have a larger front-oriented (Y) gain that grows smoothly within diversified angles and a lower steady back-oriented (−Y) gain, in comparison with a common antenna. As a result, the radiation pattern of the antenna system 100 is clearly front-oriented.

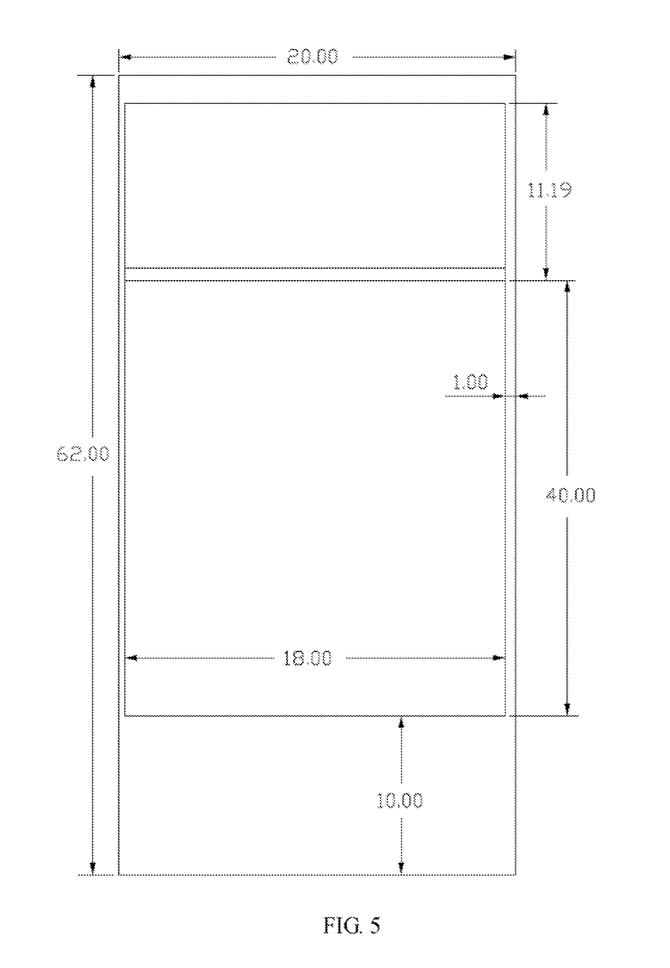

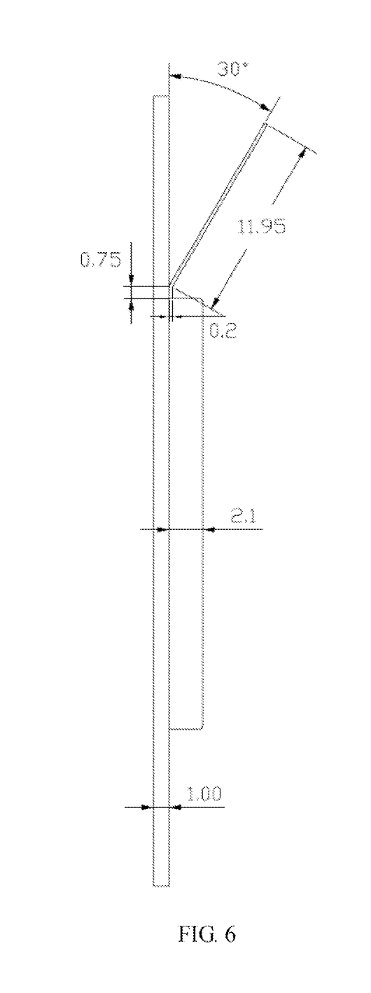

FIG. 5 and FIG. 6, are schematic diagrams of embodiment of exemplary structures of the substrate 10, the reflection portion 32 and the metal shielding cover 34 with designated sizes in millimeters (mm) in accordance with the present disclosure. The length, width and thickness of the substrate 10 are substantially 62 mm, 20 mm and 1 mm respectively. The length and width of the vacancy portion 12 are substantially 20 mm and 11.25 mm respectively. The length and width of the metal ground portion 14 are substantially 50.75 mm and 20 mm respectively. The length and width of the RF component portion 141 are substantially 40.75 mm and 20 mm respectively. The length and width of the non-RF component portion 143 are substantially 20 mm and 10 mm respectively. The length, width and thickness of the metal shielding cover 32 are substantially 40 mm, 18 mm and 2.1 mm respectively. The length, width and thickness of the metal reflection board 34 are substantially 18 mm, 11.95 mm and 0.2 mm respectively. The length, width and thickness of the connection part between the metal reflection board 34 and the metal shielding cover 32 are substantially 18 mm, 0.75 mm and 0.2 mm respectively. A part of the metal reflection board 34 extends at 30 degree angle on the vacancy portion 12 of the substrate 10.

In the present embodiment, the sizes of the RF component portion 141 and the non-RF component portion 143 are linked with the layout of RF components and non-RF components in the substrate 10, and relatively, as the metal shielding cover 32 covers the RF component portion 141, the sizes of the metal shielding cover 32 are linked with the layout of RF components in the substrate 10. In one embodiment, the sizes of the metal ground portion 14, the RF component portion 141, the non-RF component portion 143 and the metal shielding cover 32 can be adjusted according to the layout of RF components and non-RF components in the substrate 10.

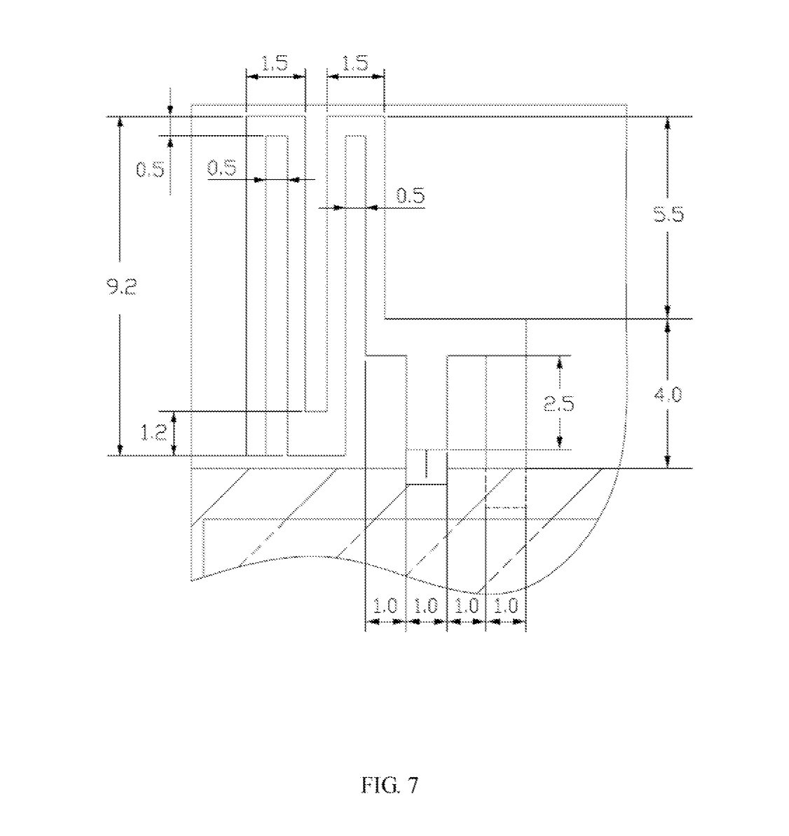

FIG. 7 is a schematic diagram of an embodiment of an exemplary structure of the first antenna 22 with designated sizes in accordance with the present disclosure. The first radiation portion 221 has a selective one of an S-shaped configuration and an M-shaped configuration, and its length, the largest width and the least width are 37.6 mm, 1 2 mm and 0.5 mm respectively. The lengths and widths of connection parts between the first radiation portion 221 and the second radiation portion 223, the second radiation portion 223 and the third radiation portion 225 are 2.5 mm and 1 mm respectively. The length and width of a connection part between the second radiation portion 223 and the metal feeding line are 3.5 mm and 1 mm respectively. The length and width of the third radiation portion 225 are 4 mm and 1 mm respectively.

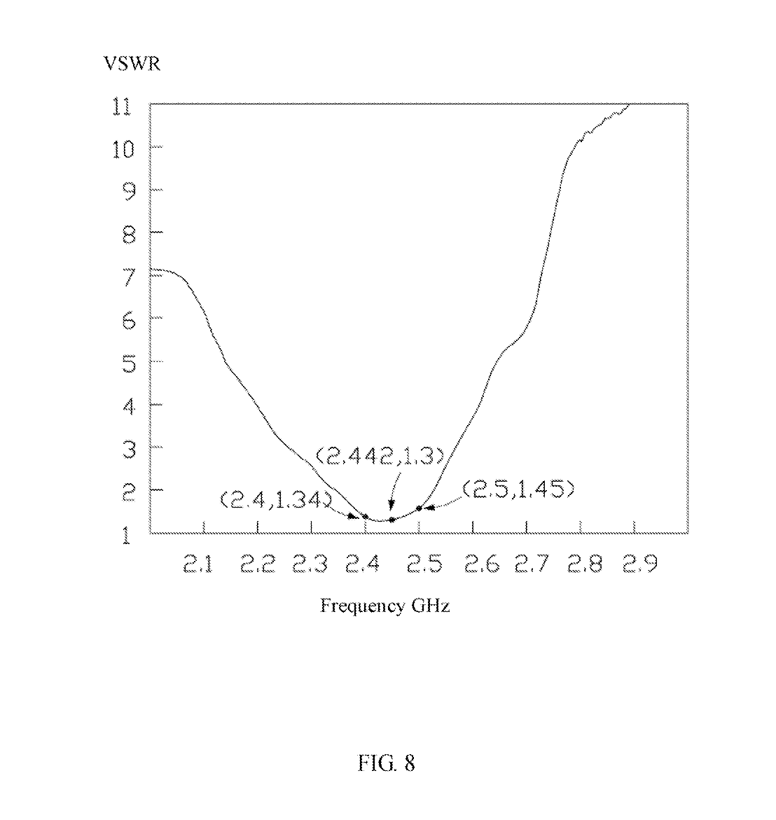

FIG. 8 is a test diagram of an embodiment of a voltage standing wave ratio (VSWR) of the antenna system 100. In the present embodiment, the antenna system 100 operates at between 2.4-2.5 gigahertz (GHz). As indicated in FIG. 8, when the antenna system 100 operates at 2.4 GHz, 2.442 GHz and 2.5 GHz, the corresponding VSWRs are 1.34, 1.3 and 1.45 respectively, which are less than 1.5 and meet the industrial requirement.

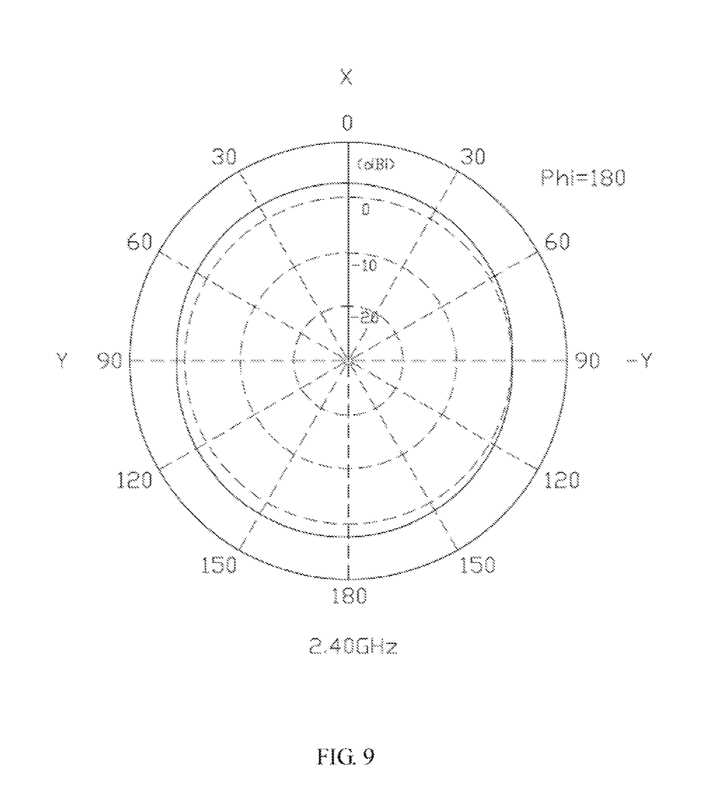

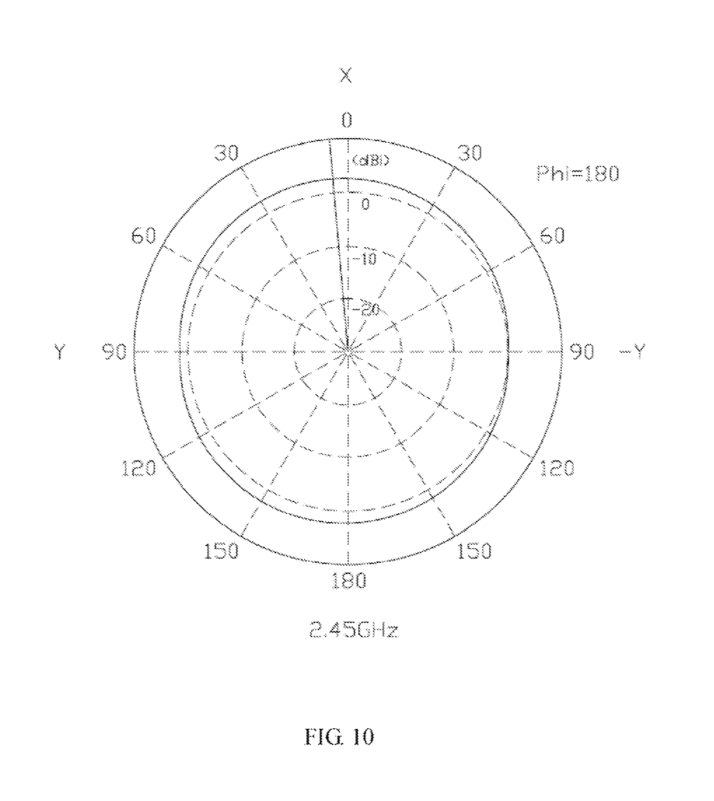

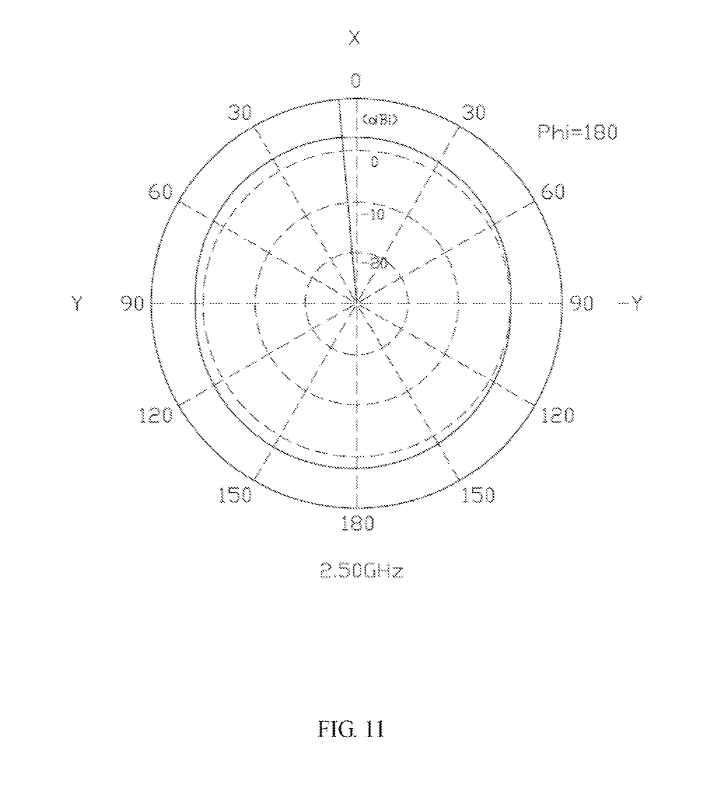

FIG. 9, FIG. 10 and FIG. 11 are diagrams showing exemplary radiation patterns on an X-Y horizontal plane when the antenna system 100 operates at 2.4 GHz, 2.442 GHz and 2.5 GHz. As indicated in the test result, the antenna system 100, operating in the three frequency bands, has a clear front-orientation and high gain, and varies its gain smoothly within 240 degrees. The highest front-oriented gain of the antenna system 100 can be 2.5 dBi, and in comparison, the back-oriented gain is reduced to 0 dBi and becomes stable.

In present disclosure, the metal reflection board 34, with a variable extending angle on the vacancy portion 12, works with the metal shielding cover 32 to protect the antenna system 100 from interference. The F shape of radiation portion of the first antenna 22 and the second antenna 24, and along with the symmetric relationship between the antennas, contribute to the small size and high stable gain with high orientation of the antenna system 100. The first antenna 22 and the second antenna 24, taking advantage of the metal reflection board 34, have a larger front-oriented (Y) gain that grows smoothly within diversified angles and a lower steady back-oriented (−Y) gain, in comparison with a common antenna. As a result, the radiation pattern of the antenna system 100 is clearly front-oriented.

What is claimed is:

1. An antenna system, comprising:
a substrate, comprising a vacancy portion, a metal ground portion, a first antenna and a second antenna, wherein the first antenna and the second antenna are disposed on the vacancy portion;
a reflection portion located in the substrate, comprising a metal shielding cover and a metal reflection board, wherein the metal shielding cover covers part of the metal ground portion, and a first part of the metal reflection board is connected to the metal shielding cover and a second part of the metal reflection board is angulated at an angle of 0-90 degrees to the vacancy portion for changing a radiation pattern of the antenna system.

2. The antenna system as claimed in claim 1, wherein the metal ground portion further comprises a radio frequency (RF) component portion and a non-RF component portion, wherein the metal shielding cover covers the RF component portion of the metal ground portion to shield electromagnetic interference.

3. The antenna system as claimed in claim 2, wherein the first part of the metal reflection board is connected to the metal shielding cover close to the vacancy portion, and the second part of the metal reflection board is angulated at an angle of 30 degrees to the vacancy portion of the substrate.

4. The antenna system as claimed in claim 1, wherein lengths of the first antenna and the second antenna are equal to a quarter of wavelengths of electromagnetic signals radiated by the first antenna and the second antenna respectively.

5. The antenna system as claimed in claim 1, wherein the first antenna and the second antenna are symmetric along an axis.

6. The antenna system as claimed in claim 1, wherein each of the first antenna and the second antenna comprises a first radiation portion that has a selective one of an S-shaped configuration and an M-shaped configuration, a T-shaped second radiation portion and a long striped third radiation portion; wherein the first radiation portion, the second radiation portion and the third radiation portion are connected in series, and the second radiation portion and the third radiation portion collectively form an F shape.

7. The antenna system as claimed in claim 6, wherein the first antenna further comprises a metal feeding line, and a first terminal of the metal feeding line is electronically connected to a middle protruding terminal of the second radiation portion of the first antenna, and a second terminal of the metal feeding line is coupled with the vacancy portion for feeding electromagnetic signals to the first antenna.

8. The antenna system as claimed in claim 7, wherein a terminal of the third radiation portion of the first antenna is electronically connected to the metal ground portion of the substrate.

9. The antenna system as claimed in claim 8, wherein the second antenna further comprises another metal feeding line, and a first terminal of the metal feeding line of the second antenna is electronically connected to a protruding portion of the T-shaped second radiation portion of the second antenna, and a second terminal of the metal feeding line of the second antenna is coupled with the vacancy portion for feeding electromagnetic signals to the second antenna.

10. The antenna system as claimed in claim 9, wherein a terminal of the third radiation portion of the second antenna is electronically connected to the metal ground portion of the substrate.
